(19) United States
(12) Patent Application Publication
(10) Pub. No.: US 2026/0223187 A1
(43) Pub. Date: Jul. 30, 2026

(54) SYSTEMS AND METHODS OF SYNCHRONIZATION SIGNAL BLOCK TO RANDOM ACCESS CHANNEL OCCASION ASSOCIATION FOR PHYSICAL RANDOM ACCESS CHANNEL REPETITION

(71) Applicant: APPLE INC., Cupertino, CA (US)

(72) Inventors: Chunhai Yao, Beijing (CN); Haitong Sun, Cupertino, CA (US); Chunxuan Ye, San Diego, CA (US); Dawei Zhang, Saratoga, CA (US); Hong He, San Jose, CA (US); Wei Zeng, San Diego, CA (US)

(21) Appl. No.: 19/146,720

(22) PCT Filed: Feb. 16, 2023
(86) PCT No.: PCT/CN2023/076397

§ 371 Date: Jul. 9, 2025

(51) Int. Cl. H04W 74/0833; H04B 17/318; H04W 74/08

(52) U.S. Cl. CPC H04W 74/0833; H04B 17/328; H04W 74/0891

(57) ABSTRACT

Systems and methods for synchronization signal block (SSB)-to-random access channel (RACH) occasion (RO) association for enabling a use of physical random access channel (PRACH) repetitions are discussed herein. A network (e.g., a radio access network (RAN)) may provide a user equipment (UE) with RACH configuration information that enables the UE to identify a set of configured ROs. In some cases, the UE uses RO groups that comprise a plurality of time domain multiplexed (TDMed) ROs for PRACH repetitions of one or more random access procedure for corresponding SSB(s). The UE may use the RACH configuration information to determine the mapping of these RO groups to the configured ROs, to determine a repetition level for each of these RO groups, to identify a correspondence between the SSB of an RO group and the repetition level off the RO group, etc. Other embodiments not using formal RO groups are also described.

### TECHNICAL FIELD

This application relates generally to wireless communication systems, including wireless communication systems using random access channel (RACH) occasion (RO) groups in physical random access channel (PRACH) repetitions.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and Institute of Electrical and Electronics Engineers (IEEE) 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a portion of RACH configuration information that gives a binary indication that PRACH repetition is configured for use, according to embodiments herein.

FIG. 2 illustrates a portion of RACH configuration information that provides a priority indication for PRACH repetition behavior, according to embodiments herein.

FIG. 3 illustrates a portion of RACH configuration information that provides multiple binary indications of repetition levels that are configured for use, according to embodiments herein.

FIG. 4 illustrates a portion of RACH configuration information that provides repetition level configuration information indicating a first repetition level for first one or more random access preambles, according to embodiments herein.

FIG. 5 illustrates a table that maps between a PRACH configuration period an SSB to (single) RO association period (representing a number of PRACH configuration periods within the SSB to (single) RO association period), according to embodiments herein.

FIG. 6 illustrates a use of a set of configured ROs, according to embodiments herein.

FIG. 7 illustrates a diagram for determinations of a starting RO for PRACH repetition, according to embodiments herein.

FIG. 8A and FIG. 8B each illustrate an example of the treatment of invalid ROs in a set of configured ROs as part of SSB-to-RO group mapping, according to embodiments herein.

FIG. 9 illustrates a portion of RACH configuration information for associating an SSB with a repetition number, according to embodiments herein.

FIG. 10 illustrates a method of a UE, according to embodiments herein.

FIG. 11 illustrates a method of a UE, according to embodiments herein.

FIG. 12 illustrates a method of a UE, according to embodiments herein.

FIG. 13 illustrates a method of a UE, according to embodiments herein.

FIG. 14 illustrates a method of a RAN, according to embodiments herein.

FIG. 15 illustrates a method of a UE, according to embodiments herein.

FIG. 16 illustrates a method of a RAN, according to embodiments herein.

FIG. 17 illustrates an example architecture of a wireless communication system, according to embodiments disclosed herein.

FIG. 18 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

To improve NR coverage enhancement, it may be beneficial to improve upon physical random access channel (PRACH) coverage mechanisms used in a wireless communication system. For example, it may be beneficial to use multiple PRACH transmissions with same beams for a 4-step RACH procedure. Further, in some cases, it may be beneficial to specify PRACH transmissions with different beams for a 4-step RACH procedure. In some configurations, such enhancements to PRACH mechanisms may be targeted for FR2, but may also apply to FR1 in various cases. In some configurations, such enhancements to PRACH mechanisms may target short PRACH formats, but may also be applied with respect to other formats in other cases.

It may be that in the case of multiple PRACH transmissions on a same uplink (UL) transmit (Tx) beam, one of various options may be implemented. In a first such option, the base station may configure a single value for a number of (multiple) PRACH transmissions that is used with respect to all UL Tx beams. In a second such option, the base station may configure one or multiple values for the number of multiple PRACH transmissions (e.g., each UL Tx beam is assigned a particular number of PRACH transmissions, where different beams may be assigned different such numbers). Note that under the second option, it may be understood that the system correspondingly supports multiple PRACH repetition levels (where each PRACH repetition level corresponds to a different number of PRACH transmissions being used).

Herein, it may be understood that reference to multiple PRACH transmissions of a random access procedure on the same UL Tx beam denotes an execution of repeated transmissions of a same random access preamble for the random access procedure on the UL Tx beam. Herein, the terms “PRACH repetitions” and “PRACH repetition behavior” may be understood to correspond to these circumstances.

Options for the determination of random access channel (RACH) occasions (ROs) used as part of PRACH repetition behavior are now discussed. For the multiple PRACH transmissions that use a same UL Tx beam under this PRACH repetition behavior, in order to differentiate the case of multiple PRACH transmissions on the same UL Tx beam with the case where a single PRACH transmission is used on the UL Tx beam, various options may be considered. In a first option, the multiple PRACH transmissions may be transmitted with separate preambles from those used by single PRACH transmissions, and on shared ROs used by both PRACH repetitions and single PRACH transmissions. In a second option, PRACH repetitions may be transmitted on separate ROs from ROs used by single PRACH transmissions. In a third option, it may be that some of a set of PRACH repetitions are transmitted using a separate preamble from preambles used by single PRACH transmissions on shared ROs used by both PRACH repetitions and single PRACH transmissions, while another part of the set of PRACH repetitions are transmitted on separate ROs from ROs used by the single PRACH transmissions. Note that in such cases, the use of a shared or separate RO means that the RO is shared or separated with the RO used by single PRACH transmissions.

Accordingly, various issues with regard to particular implementations of PRACH coverage enhancement mechanisms may need to be resolved.

A first issue relates to PRACH repetition configuration, in that a manner of differentiating the preambles for PRACH repetition is needed for both cases where the same ROs as single PRACH transmissions are used and/or cases where different ROs from ROs used by single PRACH transmissions are used.

A second issue relates to the manner of associating a synchronization signal block (SSB) to ROs to supporting PRACH repetition. For example, in NR systems implementing time division duplex (TDD), the time density of available (e.g, configured) ROs is relatively limited (due to more limited density of UL slots under TDD as compared to a density of UL slots under a division duplex (FDD) case). However, some SSB-to-RO mapping mechanisms may map PRACH transmissions to the ROs in a frequency domain first, followed by time domain. This can cause the ROs for a same SSB have longer transmission delay. Assuming continued use of such a frequency-domain-first mapping mechanism, the access delay experienced by a UE operating with the network in a TDD manner may increase once the UE implements the use of PRACH repetition behavior.

A third issue relates to the determination/identification of a starting RO for PRACH repetitions that are to be used.

A fourth issue relates to the UE behavior when an invalid RO (relative to the PRACH repetition scheme) exists. For example, it may be unclear whether such an invalid RO is merely postponed, or if it is dropped altogether.

A fifth issue relates to the manner of providing for different RACH repetition levels for different SSBs within the system.

### Embodiments of PRACH Repetition Configuration

RACH configuration information for configuring the use of PRACH repetitions at the UE may be provided to the UE by the network in radio resource control (RRC) signaling. For example, a base station may broadcast one or more system information blocks (SIB) (e.g., an SIB1) having the some or all of the RACH configuration information. Alternatively or additionally, RRC signaling provided by a base station to the UE in a dual connectivity (DC) context may include some or all of the RACH configuration information (e.g., the RACH configuration information may be provided in whole or in part by an LTE base station in a ServingCellConfigCommon information element (IE) in the case of E-UTRAN NR DC (EN-DC).

In some embodiments, an indication (e.g., a binary indication) that PRACH repetition is configured for at least one random access procedure performable by the UE may be provided in RACH configuration information. For example, a FeatureCombination IE of a RACH indication and partitioning function used within the system may make this indication using a spare bit.

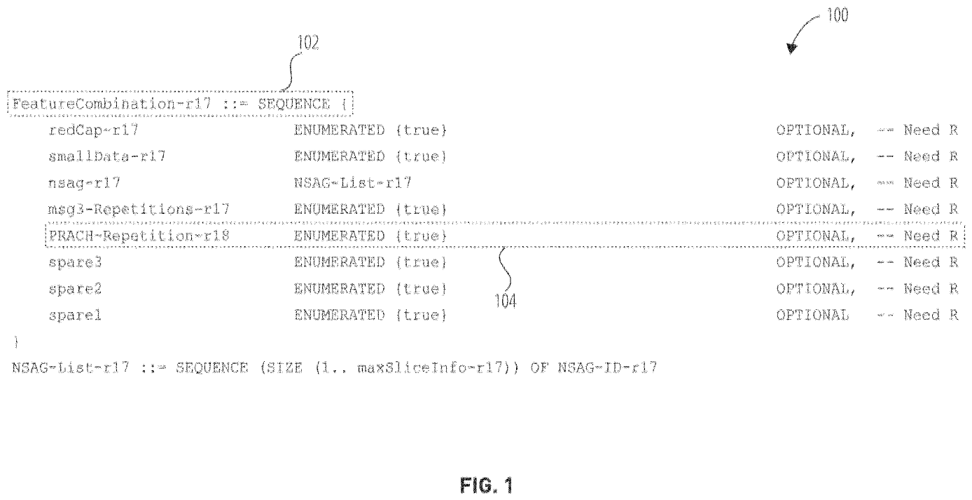

FIG. 1 illustrates a portion 100 of RACH configuration information that gives a binary indication that PRACH repetition is configured for use, according to embodiments herein. The portion 100 includes a FeatureCombination IE 102. The FeatureCombination IE 102 may include a PRACH-Repetition-r18 bit 104 that makes a binary indication that PRACH repetition is configured for use in at least one random access procedure performable by the UE.

In some embodiments, RACH configuration information may include an indication of the priority of PRACH repetition behavior at the UE. This information may be sent in SIB1 and/or in a ServingCellConfigCommon IE (e.g., in the case of EN-DC).

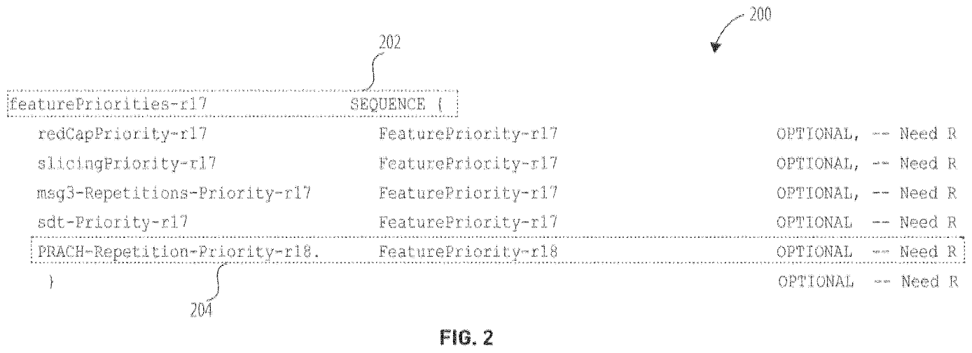

FIG. 2 illustrates a portion 200 of RACH configuration information that provides a priority indication for PRACH repetition behavior, according to embodiments herein. The portion 200 includes a featurePriorities-r17 IE 202. The featurePriorities-r17 IE 202 may include a PRACH-Repetition-Priority-r18 IE 204 that indicates a priority of the PRACH repetition behavior to the UE.

Within the configurations discussed herein, the preambles used for PRACH repetition may be configured in separate ROs from ROs used by single PRACH transmissions. Alternatively, these preambles may be configured for use in shared ROs (e.g., the ROs for RACH features such as contention free random access (CFRA), contention based random access (CBRA), small data transmission (SDT), etc.). The configuration of ROs to use for the PRACH repetition behavior may be configured via a same message (e.g., a same msg1-FreqeuncyStart) that configures ROs for these other RACH features, or may be configured in separate signaling (e.g., a separate msg1-FreqeuncyStart that is for the PRACH repetition behavior in particular).

In some cases, multiple PRACH repetition levels (where a number of PRACH repetitions used is different corresponding to each repetition level) are used. In a first option for configurations for multiple PRACH repetition level use, PRACH resources may be separately configured for each PRACH repetition level in a FeatureCombination IE. In such cases, one PRACH repetition level may be considered as one feature, another PRACH repetition level may be considered a second feature, and so on. For example, a first PRACH repetition level may use a first spare bit of the FeatureCombination IE, a second PRACH repetition level may use a second spare bit of the FeatureCombination IE, and so on.

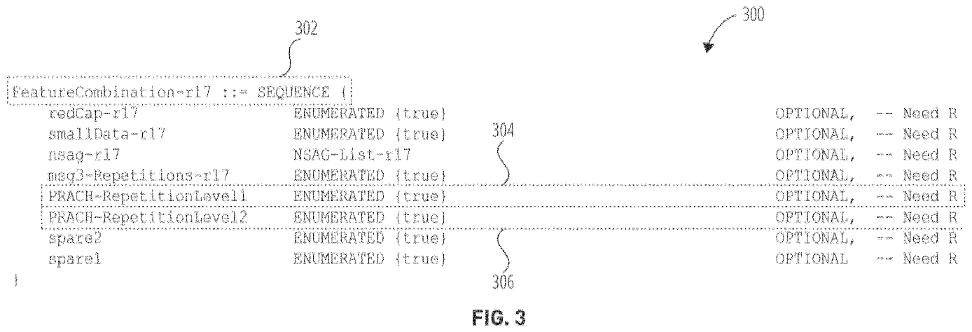

FIG. 3 illustrates a portion 300 of RACH configuration information that provides multiple binary indications of repetition levels that are configured for use, according to embodiments herein. The portion 300 includes a FeatureCombination IE 302. The FeatureCombination IE 302 includes a RACH-RepetitionLevel1 bit 304 corresponding to a first repetition level than can be set to indicate that the first repetition level is configured for use. The FeatureCombination IE 302 further includes a RACH-RepetitionLevel2 bit 306 corresponding to a second repetition level that can be set to indicate that the second repetition level is configured for use.

In other cases, as is described herein, it may instead by that PRACH repetition is considered as a singular feature (regardless of the number of repetition levels implemented). In such cases, each repetition level may be differentiated by preambles in the shared ROs. In such cases, additional signaling may be needed to configure preambles for each repetition level.

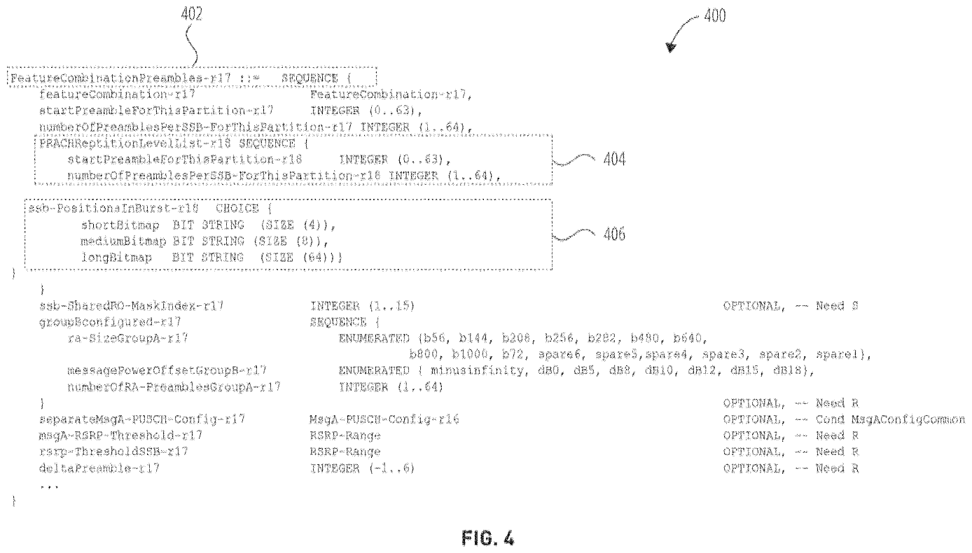

FIG. 4 illustrates a portion 400 of RACH configuration information that provides repetition level configuration information indicating a first repetition level for first one or more random access preambles, according to embodiments herein. The portion 400 includes a FeatureCombinationPreambles-r17 IE 402. The FeatureCombinationPreambles-r17 IE 402 includes a PRACHRepititionLevelList-r18 IE 404 corresponding to a repetition level that may be used. The information provided by the PRACHRepititionLevelList-r18 IE 404 (such as the startPreambelForThisPartition-r18 integer and the numberOfPreamblesPerSSB-ForThisPartition-r18 integer, as illustrated in FIG. 4) may be used to identify one or more preambles that are used at that repetition level.

The FeatureCombinationPreambles-r17 IE 402 further includes an ssb-PositionsInBurst-r18 IE 406 that may associate one or more SSBs with the preambles indicated by the PRACHRepititionLevelList-r18 IE 404, using a bitmap (as illustrated in FIG. 4).

Note that while FIG. 4 illustrates the use of repetition level configuration information comprising a single PRACHRepititionLevelList-r18 IE 404 and a single associated ssb-PositionsInBurst-r18 IE 406, it may be that multiple PRACHRepititionLevelList-r18 IEs (along with corresponding ssb-PositionsInBurst-r18 IEs) may be provided as repetition level configuration information. In this way, multiple sets of one or more preambles may be assigned to multiple different repetition levels that are configured for use.

### SSB-to-RO Association

Various options SSB-to-RO association that may reducing the PRACH repetition delay are now discussed.

A first option for SSB-to-RO association defines a mechanism for mapping RO groups for PRACH repetitions of random access procedures corresponding to SSBs on a set of configured ROs. In such cases, each RO group may be understood to include ROs used by a set of PRACH repetitions for a random access procedure corresponding to an SSB, where the set of PRACH repetitions occurs on a UL Tx beam associated with that SSB.

First, PRACH repetitions of a random access procedure corresponding to one SSB are mapped on ROs of an RO group for PRACH repetitions of a random access procedure corresponding to that SSB in the time domain. In other words, the ROs for the PRACH repetitions for the SSB are time domain multiplexed (TDMed) within the RO group (e.g., they may occur at consecutively at different times and all use the same frequency resource). In these circumstances, the RO group may be for use within a single PRACH slot, or may extend across PRACH slots if necessary.

An analogous arrangement may apply for RO groups corresponding to multiple SSBs.

Then, it may be that multiple such RO groups for the SSBs are mapped to the configured ROs first in the time domain and on a first frequency resource. Then, if it occurs that there are not sufficient unused time domain resources remaining on the first frequency resource for a next RO group during the mapping, following RO group(s) for corresponding SSBs are mapped in the time domain but using a second/next frequency resource in the frequency domain (if a second/next such frequency resource is available). In other words, RO groups for the random access procedures corresponding to the SSBs are first mapped in a TDMed manner, and then in a frequency division multiplexed (FDMed) manner.

In cases where multiple PRACH repetition levels are defined, when an RO group is associated with a PRACH repetition level, that RO group may be understood to use a number of consecutive TDMed ROs for the repetition number of that PRACH repetition level. For example, if an RO group is associated with a PRACH repetition level using a PRACH repetition number of four, four consecutive TDMed ROs will be used as part of that RO group. In such cases, it may be that the PRACH repetition level and preambles in associated RO groups are indicated via SIB1.

Under the first option, SSB-to-RO group association periods (also referred to herein as “RO group association periods”) may be used. The RO group association period may be of a duration that is one or more PRACH configuration period(s) used at the UE.

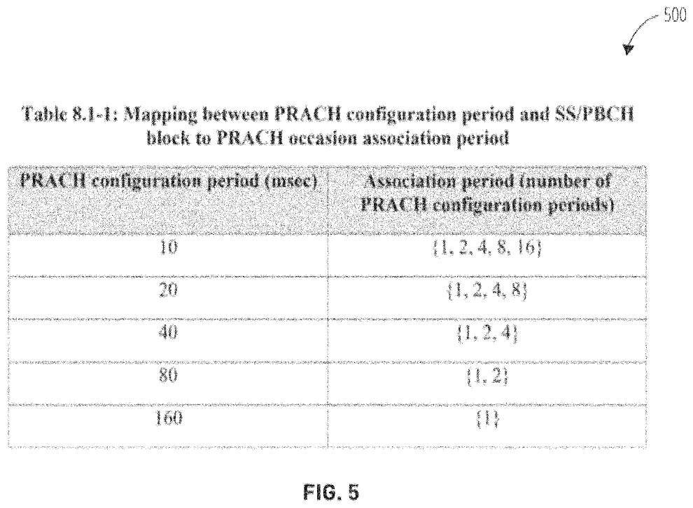

FIG. 5 illustrates a table 500 that maps between a PRACH configuration period an SSB to (single) RO association period (representing a number of PRACH configuration periods within the SSB to (single) RO association period), according to embodiments herein. As illustrated, a PRACH configuration period of 10 milliseconds (ms) allows for one, two, four, eight, or 16 PRACH configurations periods within the SSB to (single) RO association period, a PRACH configuration period of 20 ms allows for one, two, four, or eight PRACH configurations periods within the SSB to (single) RO association period, a PRACH configuration period of 40 ms allows for one, two, or four PRACH configurations periods within the SSB to (single) RO association period, a PRACH configuration period of 80 ms allows for one or two PRACH configurations periods within the SSB to (single) RO association period, and a PRACH configuration period of 160 ms allows for one PRACH configuration period within the SSB to (single) RO association period.

Thus, it may be understood in such embodiments that an RO group association period may be an integer multiple of one of 10 ms, 20 ms, 40 ms, 80 ms, and/or 160 ms as provided in the table 500.

In some embodiments, it may be understood that an RO group association period within a set of configured ROs has at least one RO group for each SSB associated with that RO group association period. It is noted that this may be considered a minimum condition for the RO group association period, which allows for the case that an RO group association period may have more than these ROs (e.g., may use have one or more second/third/additional ROs for one or more of the SSBs for the RO group association period).

In some embodiments, RO groups are ordered within the RO group association period first in a time domain and then in a frequency domain according to their corresponding ones of the set of SSBs. In some of these cases, the system may expect that the at least one RO group for each SSB (not including any second/third/additional ROs for those SSBs) is on a same frequency resource within the association period.

In other embodiments, RO groups are ordered within the RO group association period first in a frequency domain and then in a time domain according to their corresponding ones of the set of SSBs.

In some embodiments, different RO groups for different SSBs are associated with different PRACH repetition levels. In such cases, it may be that RO groups for these SSBs are arranged according to different RO group association periods for each such PRACH repetition level. In other cases, a same RO group association period is used for all RO groups for all SSBs of a cell, regardless of repetition number. In such cases, the RO group association period may be determined by using the RO group in this set having the highest number of repetitions.

It is contemplated that a new RRC parameter may be introduced and used by a network to indicate to a UE that the SSB-to-RO group mapping described in relation to the first option is used. This signaling may be found in, for example, SIB1. It may be in some embodiments that if SSB-to-RO group mapping according to the first option is indicated, then SSB-to-RO group mapping (e.g., within an RO group association period) is performed first in the time domain and then in the frequency domain.

FIG. 6 illustrates a use of a set of configured ROs 600, according to embodiments herein. A set of RACH configuration information 602 may indicate that time domain first mapping is to be used, that there is a single SSB per RO (“ssb-perRACH-Occasion=1”), that two frequency resources are configured for the configured ROs 600 (“msg1-FDM=2”), and that there are 2 ROs per RO group.

The example RO groups 604 illustrates RO group formulations that may be mapped to the configured ROs 600 under the RACH configuration information 602, as will be described next. Note that the different shading for each of the example RO groups 604 is meant to denote that different example RO groups 604 can correspond to a different SSBs.

In view of the RACH configuration information 602 and the example RO groups 604, the use of the configured ROs 600 is now described in further detail. An RO group association period 606 used at the UE has been illustrated. In the example of FIG. 6, there may be four SSBs associated with the RO group association period 606 (“SSB #0,” “SSB #1”, “SSB #2,” and “SSB #3”), and the system may expect that least one RO group for each SSB associated with the RO group association period 606 is on a first frequency resource of the RO group association period 606.

Accordingly, the RO group #0 608, which is made up of PRACH repetitions of a random access procedure corresponding to SSB #0, the RO group #1 610, which is made up of PRACH repetitions for a random access procedure corresponding to SSB #1, the RO group #2 612, which is made up of PRACH repetitions for a random access procedure corresponding to SSB #2, and the RO group #3 614, which is made up of PRACH repetitions for a random access procedure corresponding to SSB #3 are all mapped within the RO group association period 606 in the configured ROs 600 and on a first frequency resource 624.

Further, the RO group #4 616, which is made up of PRACH repetitions of a random access procedure corresponding to SSB #0, the RO group #5 618, which is made up of PRACH repetitions for a random access procedure corresponding to SSB #1, the RO group #6 620, which is made up of PRACH repetitions for a random access procedure corresponding to SSB #2, and the RO group #7 622 which is made up of PRACH repetitions for a random access procedure corresponding to SSB #3 are all mapped within the RO group association period 606 in the configured ROs 600 on remaining ROs of the configured ROs 600 (which in this case are located on a second frequency resource 626.

In a second option for SSB-to-RO association, it may be that the use of formal RO groups (as was discussed in the first option) for PRACH repetition is not used. Rather, the network may configure new ROs for PRACH repetition behavior (apart from ROs used by random access procedures using single PRACH transmissions). In such cases, the new ROs for PRACH repetitions may be configured within the same frequency domain location as first ROs for single PRACH transmissions. Further, the new ROs may follow the RO associated with the same SSB in the first ROs in a time domain. The new ROs may occupy, for example, uplink slots of a TDD slot configuration that follows the slot for the first ROs for single PRACH transmissions.

In a third option for SSB-to-RO association the network may configure new ROs for PRACH repetition behavior (apart from ROs used for random access procedures using single PRACH transmissions). Further, under the third option, it may be that the ROs for PRACH repetition are in a different frequency domain location as the ROs used for the random access procedures using single PRACH transmissions. In such cases, it may be that a PRACH configuration index configures more ROs for PRACH repetition behavior than are configured for the single PRACH transmission case.

### Determinations of a Starting RO for PRACH Repetition

In some wireless communications systems, a starting RO for a set of PRACH repetitions of a set of random access procedures corresponding to a set of SSBs may be determined as follows.

First, a starting RO offset may be indicated by the network to the UE. This offset may be understood as being relative to system frame number (SFN) zero. In other cases, this offset may be understood/measured in terms of ms relative to an association pattern period or an RO group association period used by the UE. The starting RO offset may be indicated by SIB1. Examples of values that this starting RO offset can take include zero or some integer multiple (including one) of an association pattern period or used at the UE.

Further, a starting RO periodicity may be indicated by the network to the UE. It may be that the starting RO periodicity is configured by the network such that at least one RO group for each of the set of SSBs occurs within one starting RO periodicity. The starting RO periodicity accordingly defines a duration between UE transmissions of sets of PRACH repetitions for sets of random access procedures for the set of SSBs (after/with respect to the application of the starting RO offset). The starting RO periodicity may be an integer multiple (including one) of an association pattern period used by the UE, or relative to an association period or an RO group association period used by the UE.

An overall RO density may accordingly be adjusted by the network by providing the UE with a different starting RO periodicity, which accordingly changes the frequency with which sets of PRACH repetitions for sets of random access procedures for the set of SSBs are transmitted by the UE. Note that a larger starting RO periodicity means fewer reserved resources for PRACH transmission (particularly for a separated RO scenario), and such resources could then be used instead for UL data transmission.

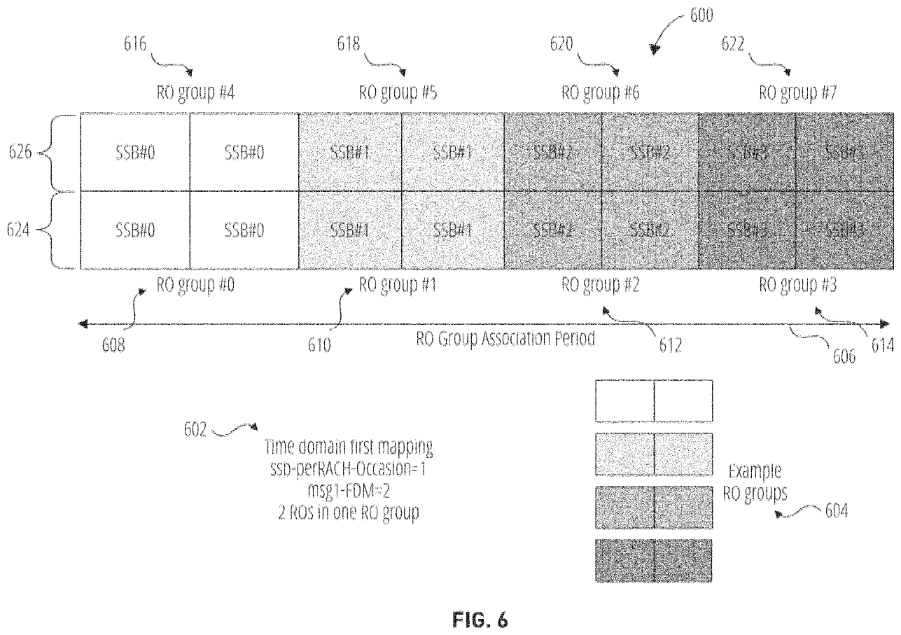

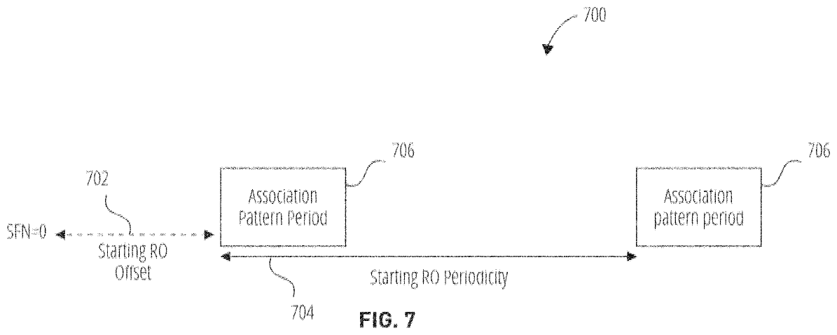

FIG. 7 illustrates a diagram 700 for determinations of a starting RO for PRACH repetition, according to embodiments herein. The diagram 700 illustrates that a starting RO offset 702 (e.g., as provided by the network to the UE) is determined relative to SFN zero. Once this offset is accounted for, a first set of PRACH repetitions for sets of random access procedures for a set of SSBs may be transmitted.

The network may also provide the UE with a starting RO periodicity 704. After the initial transmission of the first set of PRACH repetitions, transmission of additional sets of PRACH repetitions for sets of random access procedures for the set of SSBs may re-occur according to the starting RO periodicity 704. As illustrated, the duration of the starting RO periodicity 704 may be a multiple of an Association pattern period 706 used at the UE (which may be, in some cases, up to 160 ms).

### Treatment of Invalid ROs for SSB-to-RO Group Mapping

In some embodiments where RO groups are mapped to configured ROs as is described herein, the RO group is considered as a whole/as a single unit as part of the mapping procedure. Accordingly, if all ROs in an RO group for the PRACH repetitions for a random access procedure for a (e.g., next) SSB cannot mapped consecutively/in a TDMed manner to unused configured ROs within an RO group association period and on a single frequency resource, then any unused configured ROs in that frequency resource are considered as invalid ROs, and are dropped/not used for the SSB-to-RO group mapping scheme.

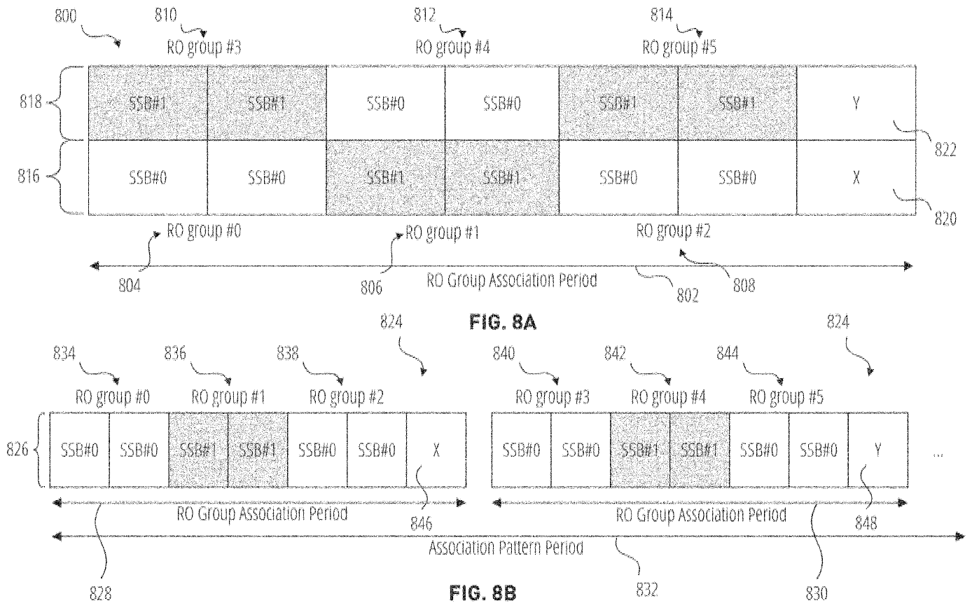

FIG. 8A and FIG. 8B each illustrate an example of the treatment of invalid ROs in a set of configured ROs as part of SSB-to-RO group mapping, according to embodiments herein. In the each of FIG. 8A and FIG. 8B, random access procedures corresponding two SSBs (“SSB #1” and “SSB #2”) each use two PRACH repetitions, which accordingly corresponds to the use of RO groups having two ROs.

In FIG. 8A, a set of configured ROs 800 uses two frequency resources, the first frequency resource 816 and the second frequency resource 818 (e.g., “msg1-FDM=2” was received by the UE from the network in RACH configuration information). Further, an applicable RO group association period 802 has a duration equivalent to 7 ROs, as illustrated.

The UE proceeds to map the RO group #0 804, the RO group #1 806, and the RO group #2 808 in a TDMed manner on the first frequency resource 816 within the RO group association period 802. However, once the first unused RO 820 is reached, there is not sufficient room for an additional RO group having two ROs, because there is only one unused RO on the first frequency resource 816 (the first unused RO 820). Accordingly, the first unused RO 820 is dropped (not used) due to being correspondingly determined to be invalid.

Instead, the RO group #3 810 (corresponding to SSB #1, continuing the mapping pattern) is mapped to available configured ROs on the second frequency resource 818. The RO group #4 812 and the RO group #5 814 are correspondingly mapped in the TDMed manner on the second frequency resource 818.

Then, once the second unused RO 822 is reached, there is not sufficient room for an additional RO group having two ROs (because there is only one unused RO on the second frequency resource 818 (the second unused RO 822). Accordingly, the second unused RO 822 is dropped (not used) due to being correspondingly determined to be invalid.

In FIG. 8B, a set of configured ROs 824 uses a single frequency resource, the frequency resource 826. Further, the first RO group association period 828 and the second RO group association period 830 use durations equivalent to 7 ROs, as illustrated. Note that the example here, where each of the first RO group association period 828 and the second RO group association period 830 use equivalent durations, is given by way of example and not by way of limitation (in other embodiments, RO group association periods could be of different durations).

FIG. 8B further illustrates that sets of configured ROs are made available within/according to an association pattern period 832 used at the UE (which may be, e.g., 160 ms). Note that the association pattern period 832 may include more RO group association periods than the first RO group association period 828 and the second RO group association period 830 which have been expressly illustrated. Further, the association pattern period 832 may be spaced apart from a next association pattern period that uses the same patterning of RO group association periods as the one used in the association pattern period 832, with this spacing occurring according to a starting RO periodicity (e.g., as was described in relation to FIG. 7).

Assuming the illustrated features, the UE proceeds to map the RO group #0 834, the RO group #1 836, and the RO group #2 838 in a TDMed manner on the frequency resource 826 and within the first RO group association period 828. However, once the first unused RO 846 is reached, there is not sufficient room for an additional RO group having two ROs, because there is only one unused RO within the first RO group association period 828 (the first unused RO 846). Accordingly, the first unused RO 820 is dropped (not used) due to being correspondingly determined to be invalid.

The UE the proceeds to map the RO group #3 840 to next available configured ROs, which in the illustrated case are in the second RO group association period 830. Note that the RO group #3 840 corresponds to SSB #0, due to the pattern restarting due to the change from the first RO group association period 828 to the second RO group association period 830 between the mapping of the RO group #2 838 and the mapping of the RO group #3 840. The RO group #4 812 and the RO group #5 814 are correspondingly mapped in the second RO group association period 830 in the TDMed manner.

Then, once the second unused RO 848 is reached, there is not sufficient room for an additional RO group having two ROs, because there is only one unused RO within the second RO group association period 830 (the second unused RO 848). Accordingly, the second unused RO 822 is dropped (not used) due to being correspondingly determined to be invalid.

Note that while FIG. 8A and FIG. 8B illustrate cases where single unused ROs are determined to be invalid, this is given by way of example and not by way of limitation. For example, it may be that a next RO group to be mapped to a configured set of ROs uses three ROs, but there are only two remaining unused ROs within the configured ROs in the current frequency resource and within a same association period. In such a case, those two remaining ROs would (e.g., together) be dropped/unused/determined to be invalid, analogously as has been described herein. Analogously, embodiments resulting in numbers of invalid ROs other than one or two are contemplated.

### Embodiments of Per-SSB PRACH Repetition

In a live network deployment, it may be that different beams used for different SSBs beams have different coverage (for example, due to coupling loss difference, such as the shelter from a building, etc.)

Accordingly, it may be that in some embodiments, RACH configuration information includes information regarding one or more SSBs that correspond to a repetition level. For example, when RACH configuration information provides a repetition level or RO group configuration, the RACH configuration information may also indicate an SSB associated to that repetition level or RO group. In such cases, it may be that only the indicated SSBs are used/associated with the configured repetition number or RO group.

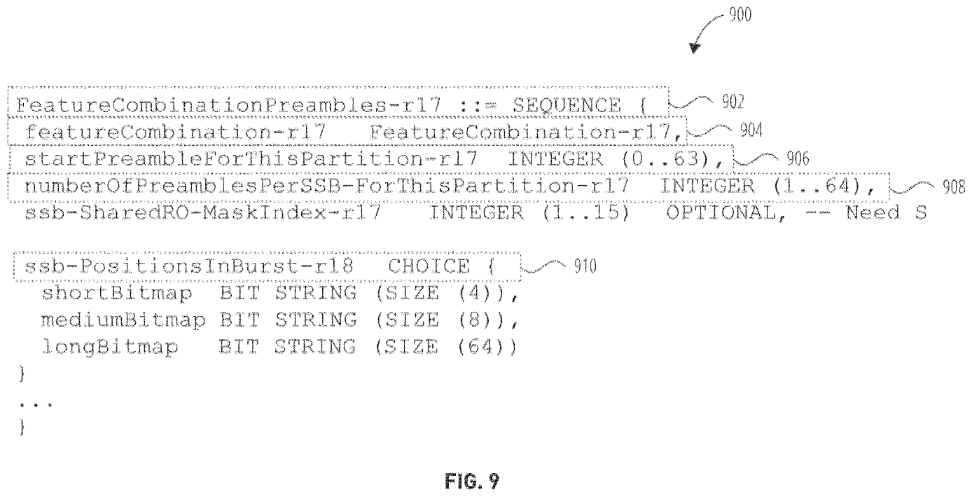

FIG. 9 illustrates a portion 900 of RACH configuration information for associating an SSB with a repetition number, according to embodiments herein. The illustrated portion 900 of the RACH configuration information includes a FeatureCombinationPreambles-r17 IE 902. The FeatureCombinationPreambles-r17 IE 902 includes a featureCombination-r17 IE 904 that indicates a repetition level. The startPreambleForThisPartition-r17 integer 906 and the numberofPreamblesPerSSB-ForThisPartition-r17 integer 908 indicate preambles allocated for the repetition level indicated in the featureCombination-r17 IE 904. Finally, the ssb-PositionsInBurst-r18 IE 910 uses a bitmap to associate one or more SSBs with the given repetition level.

Note that in cases where multiple repetitions levels exist, multiple FeatureCombinationPreambles-r17 IEs (one for each repetition level) as described in relation to FIG. 9 may be included in RACH configuration information.

### Embodiments of UE Capabilities for Supporting PRACH Repetition Behavior

The handling of UE capabilities relative to support for PRACH repetition behavior is now discussed.

In some cases, it may be that a UE does not have the capability to support/use PRACH repetitions under one or more SSB-to-RO mapping mechanisms as described herein. In some such cases, it may be that the UE does not support the use of PRACH repetition behavior generally. In other such cases, it may be that the UE can still transmit PRACH repetitions in the case that addition preambles specific to the PRACH repetition behavior are allocated to the UE.

In some cases, the UE may not have the capability to use PRACH configuration information that differentiates multiple repetition levels between different SSBs. If the UE is not capable of supporting such per-SSB PRACH repetition level configuration information, the UE may assume all SSBs use/correspond to a same repetition level.

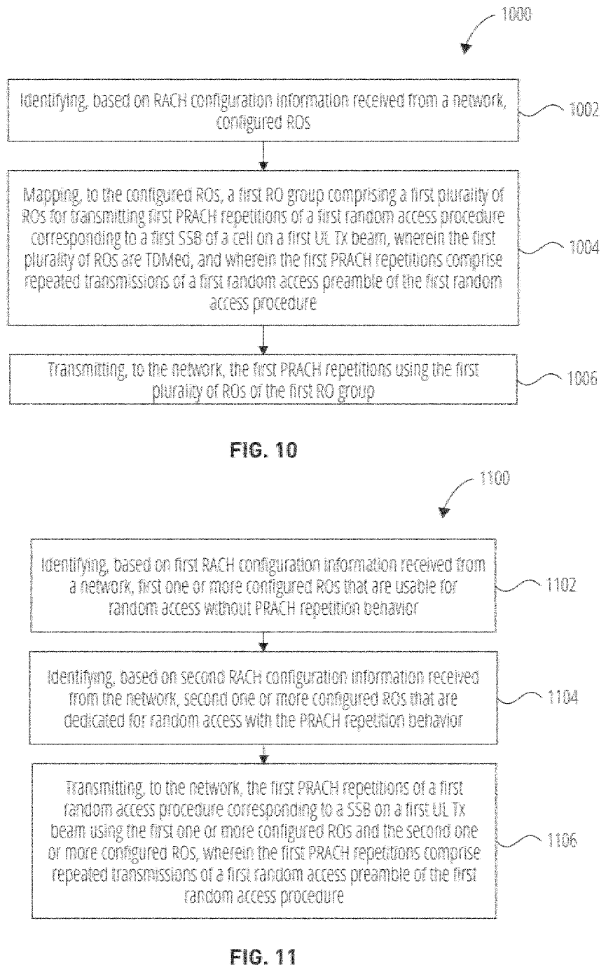

FIG. 10 illustrates a flowchart of a method 1000 of a UE, according to embodiments herein. The method 1000 includes identifying 1002, based on RACH configuration information received from a network, configured ROs.

The method 1000 further includes, mapping 1004, to the configured ROs, a first RO group comprising a first plurality of ROs for transmitting first PRACH repetitions of a first random access procedure corresponding to a first SSB of a cell on a first UL Tx beam, wherein the first plurality of ROs are TDMed, and wherein the first PRACH repetitions comprise repeated transmissions of a first random access preamble of the first random access procedure.

The method 1000 further includes, transmitting 1006, to the network, the first PRACH repetitions using the first plurality of ROs of the first RO group.

In some embodiments, the method 1000 further comprises mapping, to the configured ROs, a second RO group comprising a second plurality of ROs for transmitting second PRACH repetitions of a second random access procedure corresponding to a second SSB of the cell on a second UL Tx beam, wherein the second plurality of ROs are TDMed. In some such embodiments, the second RO group uses a same frequency resource as the first RO group and is TDMed with the first RO group. In some such embodiments, the second RO group is FDMed with the first RO group.

In some such embodiments, each of the first RO group and the second RO group are mapped to the configured ROs within a first RO group association period that includes a set of RO groups having at least one RO group for each of a set of SSBs used by the cell. In certain such cases, the set of RO groups is ordered within the RO group association period first in a time domain and then in a frequency domain according to their corresponding ones of the set of SSBs. In certain such cases, the set of RO groups is ordered within the RO group association period first in a frequency domain and then in a time domain according to their corresponding ones of the set of SSBs. In certain such cases, an association pattern period used at the UE is an integer multiple of the RO group association period.

In some such embodiments, the RACH configuration information further includes: first repetition level configuration information indicating a first repetition level defining a first PRACH repetition number and a first RSRP corresponding to the first PRACH repetition number, and second repetition level configuration information indicating a second repetition level defining a second PRACH repetition number that is different that the first PRACH repetition number and a second RSRP corresponding to the second PRACH repetition number. In certain such cases, the first RO group uses the first repetition level such that a first number of the first PRACH repetitions of the first RO group is equal to the first PRACH repetition number of the first repetition level, the second RO group uses the second repetition level such that a second number of the second PRACH repetitions of the second RO group is equal to the second PRACH repetition number of the second repetition level, and the first RO group and the second RO group are part of a same RO group association period that is determined based on a maximum between the first PRACH repetition number of the first repetition level and the second PRACH repetition number of the second repetition level. In certain such cases, the first RO group uses the first repetition level such that a first number of the first PRACH repetitions of the first RO group is equal to the first PRACH repetition number of the first repetition level, the second RO group uses the second repetition level such that a second number of the second PRACH repetitions of the second RO group is equal to the second PRACH repetition number of the second repetition level, the first RO group is part of a first RO group association period for RO groups using the first repetition level, and the second RO group is part of a second RO group association period for RO groups using the second repetition level.

In some embodiments of the method 1000, the first RO group is within a first RO group association period and on a first frequency resource, and further comprising: determining that a second RO group comprising a second plurality of ROs for transmitting second PRACH repetitions of a second random access procedure cannot be mapped in a TDMed manner to one or more unused ROs of the configured ROs that are on the first frequency resource and within the first RO group association period, and dropping the one or more unused ROs.

In some embodiments, the method 1000 comprises: transmitting to the network, a capability message indicating that the UE can use an RO grouping scheme where RO groups comprising TDMed PRACH repetitions are ordered within the configured ROs, and receiving, from the network, a system information message indicating that that UE is to use the RO grouping scheme.

FIG. 11 illustrates a flowchart of a method 1100, of a UE, according to embodiments herein. The method 1100 includes, identifying 1102, based on first RACH configuration information received from a network, first one or more configured ROs that are usable for random access without PRACH repetition behavior.

The method 1100 further includes, identifying 1104, based on second RACH configuration information received from the network, second one or more configured ROs that are dedicated for random access with the PRACH repetition behavior.

The method 1100 further includes, transmitting 1106, to the network, the first PRACH repetitions of a first random access procedure corresponding to a SSB on a first UL Tx beam using the first one or more configured ROs and the second one or more configured ROs, wherein the first PRACH repetitions comprise repeated transmissions of a first random access preamble of the first random access procedure.

In some embodiments of the method 1100, the second one or more configured ROs immediately follow the first one or more configured ROs in a time domain. In some such embodiments, the second one or more configured ROs use a same frequency resource as the first one or more configured ROs.

In some embodiments of the method 1100, the first one or more configured ROs is associated with the SSB when the first RACH configuration information is applied at the UE.

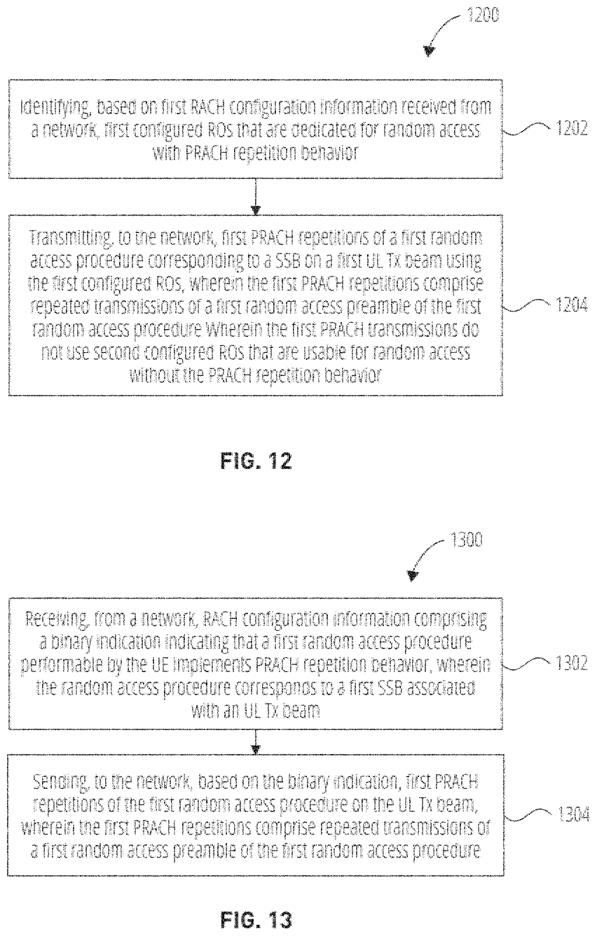

FIG. 12 illustrates a flowchart of a method 1200 of a UE, according to embodiments herein. The method 1200 includes identifying 1202, based on first RACH configuration information received from a network, first configured ROs that are dedicated for random access with PRACH repetition behavior.

The method 1200 further includes, transmitting 1204, to the network, first PRACH repetitions of a first random access procedure corresponding to a SSB on a first UL Tx beam using the first configured ROs, wherein the first PRACH repetitions comprise repeated transmissions of a first random access preamble of the first random access procedure; wherein the first PRACH transmissions do not use second configured ROs that are usable for random access without the PRACH repetition behavior.

In some embodiments of the method 1200, the first configured ROs use different frequency resources from the second configured ROs.

In some embodiments of the method 1200, a first number of the first configured ROs is greater than a second number of the second configured ROs.

FIG. 13 illustrates a flowchart of a method 1300 of a UE, according to embodiments herein. The method 1300 includes receiving 1302, from a network, RACH configuration information comprising a binary indication indicating that a first random access procedure performable by the UE implements PRACH repetition behavior, wherein the random access procedure corresponds to a first SSB associated with an UL Tx beam.

The method 1300 further includes, sending 1304, to the network, based on the binary indication, first PRACH repetitions of the first random access procedure on the UL Tx beam, wherein the first PRACH repetitions comprise repeated transmissions of a first random access preamble of the first random access procedure.

In some embodiments of the method 1300, the first PRACH repetitions are sent in ROs that are usable for random access without the PRACH repetition behavior.

In some embodiments of the method 1300, the first PRACH repetitions are sent in ROs that are dedicated for random access with the PRACH repetition behavior.

In some embodiments of the method 1300, the RACH configuration information further comprises a priority indication for the PRACH repetition behavior.

In some embodiments of the method 1300, the RACH configuration information further includes first repetition level configuration information indicating a first repetition level for the first random access preamble, and wherein a number of the first PRACH repetitions corresponds to the first repetition level. In some such embodiments, the RACH configuration information further includes second repetition level configuration information indicating a second repetition level for a second random access preamble. In some such embodiments, the RACH configuration information further indicates that the first SSB uses the first repetition level.

In some embodiments of the method 1300, the binary indication further indicates that the first random access procedure implements the PRACH repetition behavior according to a first repetition level, and wherein a number of the first PRACH repetitions corresponds to the first repetition level. In some such embodiments, the RACH configuration information further indicates that the first SSB uses the first repetition level. In some such embodiments, the RACH configuration information further comprises a second binary indication indicating that a second random access procedure performable by the UE implements the PRACH repetition behavior according to a second repetition level, wherein the second random access procedure corresponds to a second SSB, and wherein the second RACH configuration information further indicates that the second SSB uses the second repetition level.

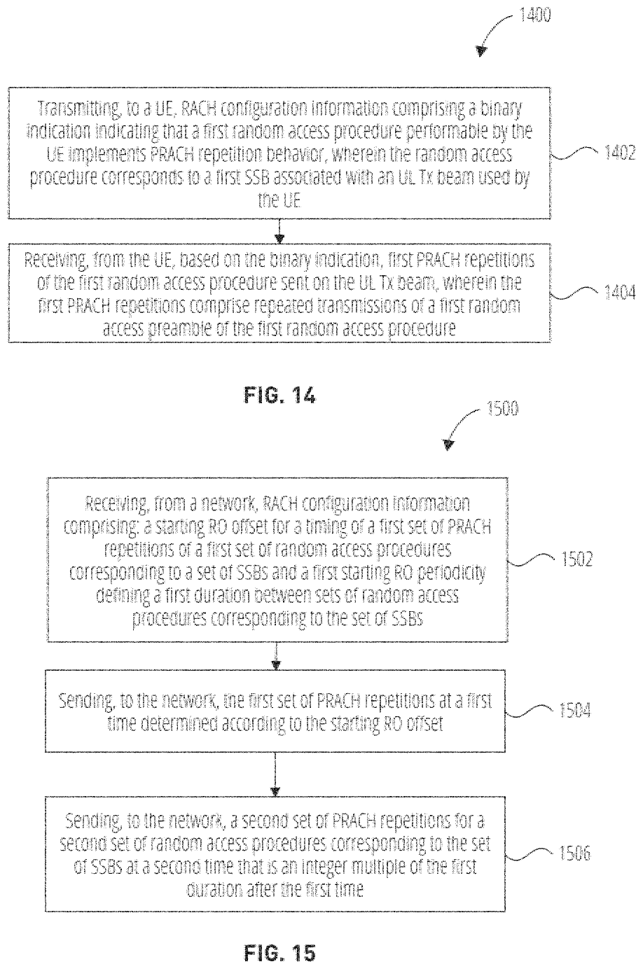

FIG. 14 illustrates a flowchart of a method 1400 of a RAN, according to embodiments herein. The method 1400 includes transmitting 1402, to a UE, RACH configuration information comprising a binary indication indicating that a first random access procedure performable by the UE implements PRACH repetition behavior, wherein the random access procedure corresponds to a first SSB associated with an UL Tx beam used by the UE.

The method 1400 further includes, receiving 1404, from the UE, based on the binary indication, first PRACH repetitions of the first random access procedure sent on the UL Tx beam, wherein the first PRACH repetitions comprise repeated transmissions of a first random access preamble of the first random access procedure.

In some embodiments of the method 1400, the first PRACH repetitions are received in ROs that are usable for random access without the PRACH repetition behavior.

In some embodiments of the method 1400, the first PRACH repetitions are received in ROs that are dedicated for random access with the PRACH repetition behavior.

In some embodiments of the method 1400, the RACH configuration information further comprises a priority indication for the PRACH repetition behavior.

In some embodiments of the method 1400, the RACH configuration information further includes first repetition level configuration information indicating a first repetition level for the first random access preamble, and wherein a number of the first PRACH repetitions corresponds to the first repetition level. In some such embodiments, the RACH configuration information further includes second repetition level configuration information indicating a second repetition level for a second random access preamble. In some such embodiments, the RACH configuration information further indicates that the first SSB uses the first repetition level.

In some embodiments of the method 1400, the binary indication further indicates that the first random access procedure implements the PRACH repetition behavior according to a first repetition level, and wherein a number of the first PRACH repetitions corresponds to the first repetition level. In some such embodiments, the RACH configuration information further indicates that the first SSB uses the first repetition level. In some such embodiments, the RACH configuration information further comprises a second binary indication indicating that a second random access procedure performable by the UE implements the PRACH repetition behavior according to a second repetition level, wherein the second random access procedure corresponds to a second SSB associated with a second UL Tx beam, and wherein the second RACH configuration information further indicates that the second SSB uses the second repetition level.

FIG. 15 illustrates a flowchart of a method 1500 of a UE, according to embodiments herein. The method 1500 includes receiving 1502, from a network, RACH configuration information comprising a starting RO offset for a timing of a first set of PRACH repetitions of a first set of random access procedures corresponding to a set of SSBs and a first starting RO periodicity defining a first duration between sets of random access procedures corresponding to the set of SSBs.

The method 1500 further includes, sending 1504, to the network, the first set of PRACH repetitions at a first time determined according to the starting RO offset.

The method 1500 further includes, sending 1506, to the network, a second set of PRACH repetitions for a second set of random access procedures corresponding to the set of SSBs at a second time that is an integer multiple of the first duration after the first time.

In some embodiments of the method 1500, the starting RO offset is measured relative to SFN zero.

In some embodiments of the method 1500, the starting RO offset is measured in milliseconds relative to an association pattern period used by the UE.

In some embodiments of the method 1500, the first starting RO periodicity is an integer multiple of an association pattern period used by the UE.

In some embodiments, the method 1500 further comprises: receiving, from the network, second RACH configuration information comprising a second starting RO periodicity defining a second duration between the sets of PRACH repetitions for the sets of random access procedures corresponding to the set of SSBs; and sending, to the network, a third set of PRACH repetitions for a third set of random access procedures corresponding to the set of SSBs at a third time that is an integer multiple of the second duration after the second time.

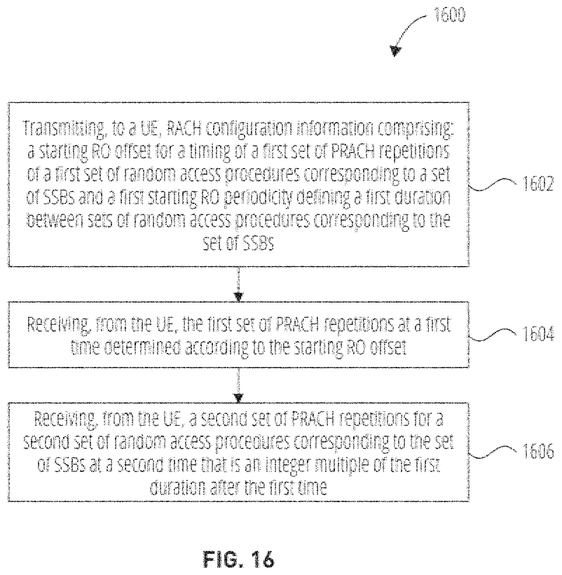

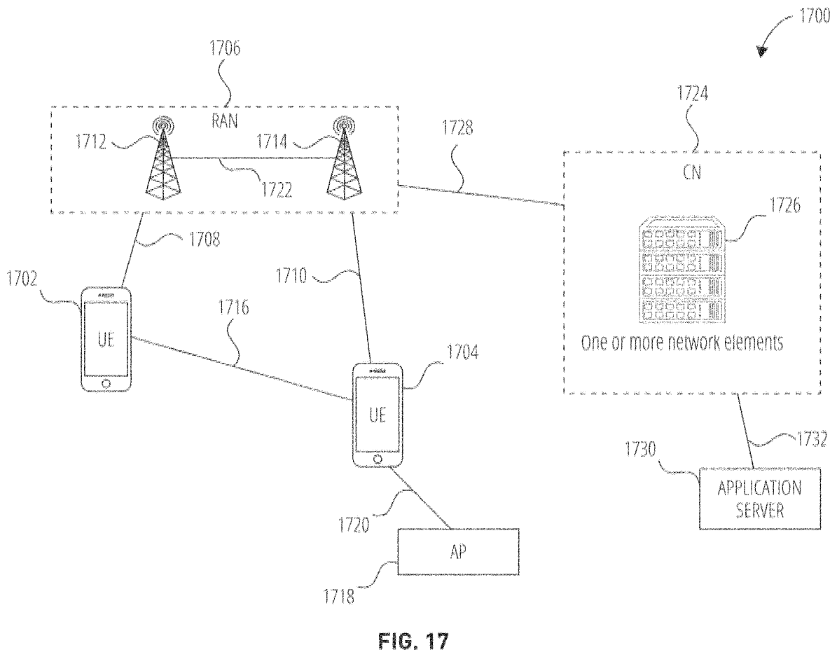

FIG. 16 illustrates a flowchart of a method 1600 of a RAN, according to embodiments herein. The method 1600 includes transmitting 1602, to a UE, RACH configuration information comprising, a starting RO offset for a timing of a first set of PRACH repetitions of a first set of random access procedures corresponding to a set of SSBs and a first starting RO periodicity defining a first duration between sets of random access procedures corresponding to the set of SSBs.

The method 1600 further includes, receiving 1604, from the UE, the first set of PRACH repetitions at a first time determined according to the starting RO offset.

The method 1600 further includes, receiving 1606, from the UE, a second set of PRACH repetitions for a second set of random access procedures corresponding to the set of SSBs at a second time that is an integer multiple of the first duration after the first time.

In some embodiments of the method 1600, the starting RO offset is measured relative to SFN zero.

In some embodiments of the method 1600, the starting RO offset is measured in milliseconds relative to an association pattern period used by the UE.

In some embodiments of the method 1600, the first starting RO periodicity is an integer multiple of an association pattern period used by the UE.

In some embodiments, the method 1600 further comprises: transmitting, to the UE, second RACH configuration information comprising a second starting RO periodicity defining a second duration between the sets of PRACH repetitions for the sets of random access procedures corresponding to the set of SSBs; and receiving, from the UE, a third set of PRACH repetitions for a third set of random access procedures corresponding to the set of SSBs at a third time that is an integer multiple of the second duration after the second time.

FIG. 17 illustrates an example architecture of a wireless communication system 1700, according to embodiments disclosed herein. The following description is provided for an example wireless communication system 1700 that operates in conjunction with the LTE system standards and/or 5G or NR system standards as provided by 3GPP technical specifications.

As shown by FIG. 17, the wireless communication system 1700 includes UE 1702 and UE 1704 (although any number of UEs may be used). In this example, the UE 1702 and the UE 1704 are illustrated as smartphones (e.g., handheld touchscreen mobile computing devices connectable to one or more cellular networks), but may also comprise any mobile or non-mobile computing device configured for wireless communication.

The UE 1702 and UE 1704 may be configured to communicatively couple with a RAN 1706. In embodiments, the RAN 1706 may be NG-RAN, E-UTRAN, etc. The UE 1702 and UE 1704 utilize connections (or channels) (shown as connection 1708 and connection 1710, respectively) with the RAN 1706, each of which comprises a physical communications interface. The RAN 1706 can include one or more base stations (such as base station 1712 and base station 1714) that enable the connection 1708 and connection 1710.

In this example, the connection 1708 and connection 1710 are air interfaces to enable such communicative coupling, and may be consistent with RAT(s) used by the RAN 1706, such as, for example, an LTE and/or NR.

In some embodiments, the UE 1702 and UE 1704 may also directly exchange communication data via a sidelink interface 1716. The UE 1704 is shown to be configured to access an access point (shown as AP 1718) via connection 1720. By way of example, the connection 1720 can comprise a local wireless connection, such as a connection consistent with any IEEE 802.11 protocol, wherein the AP 1718 may comprise a Wi-Fi® router. In this example, the AP 1718 may be connected to another network (for example, the Internet) without going through a CN 1724.

In embodiments, the UE 1702 and UE 1704 can be configured to communicate using orthogonal frequency division multiplexing (OFDM) communication signals with each other or with the base station 1712 and/or the base station 1714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1712 or base station 1714 may be implemented as one or more software entities running on server computers as part of a virtual network. In addition, or in other embodiments, the base station 1712 or base station 1714 may be configured to communicate with one another via interface 1722. In embodiments where the wireless communication system 1700 is an LTE system (e.g., when the CN 1724 is an EPC), the interface 1722 may be an X2 interface. The X2 interface may be defined between two or more base stations (e.g., two or more eNBs and the like) that connect to an EPC, and/or between two eNBs connecting to the EPC. In embodiments where the wireless communication system 1700 is an NR system (e.g., when CN 1724 is a 5GC), the interface 1722 may be an Xn interface. The Xn interface is defined between two or more base stations (e.g., two or more gNBs and the like) that connect to 5GC, between a base station 1712 (e.g., a gNB) connecting to 5GC and an eNB, and/or between two eNBs connecting to 5GC (e.g., CN 1724).

The RAN 1706 is shown to be communicatively coupled to the CN 1724. The CN 1724 may comprise one or more network elements 1726, which are configured to offer various data and telecommunications services to customers/subscribers (e.g., users of UE 1702 and UE 1704) who are connected to the CN 1724 via the RAN 1706. The components of the CN 1724 may be implemented in one physical device or separate physical devices including components to read and execute instructions from a machine-readable or computer-readable medium (e.g., a non-transitory machine-readable storage medium).

In embodiments, the CN 1724 may be an EPC, and the RAN 1706 may be connected with the CN 1724 via an S1 interface 1728. In embodiments, the S1 interface 1728 may be split into two parts, an S1 user plane (S1-U) interface, which carries traffic data between the base station 1712 or base station 1714 and a serving gateway (S-GW), and the S1-MME interface, which is a signaling interface between the base station 1712 or base station 1714 and mobility management entities (MMEs).

In embodiments, the CN 1724 may be a 5GC, and the RAN 1706 may be connected with the CN 1724 via an NG interface 1728. In embodiments, the NG interface 1728 may be split into two parts, an NG user plane (NG-U) interface, which carries traffic data between the base station 1712 or base station 1714 and a user plane function (UPF), and the S1 control plane (NG-C) interface, which is a signaling interface between the base station 1712 or base station 1714 and access and mobility management functions (AMFs).

Generally, an application server 1730 may be an element offering applications that use internet protocol (IP) bearer resources with the CN 1724 (e.g., packet switched data services). The application server 1730 can also be configured to support one or more communication services (e.g., VOIP sessions, group communication sessions, etc.) for the UE 1702 and UE 1704 via the CN 1724. The application server 1730 may communicate with the CN 1724 through an IP communications interface 1732.

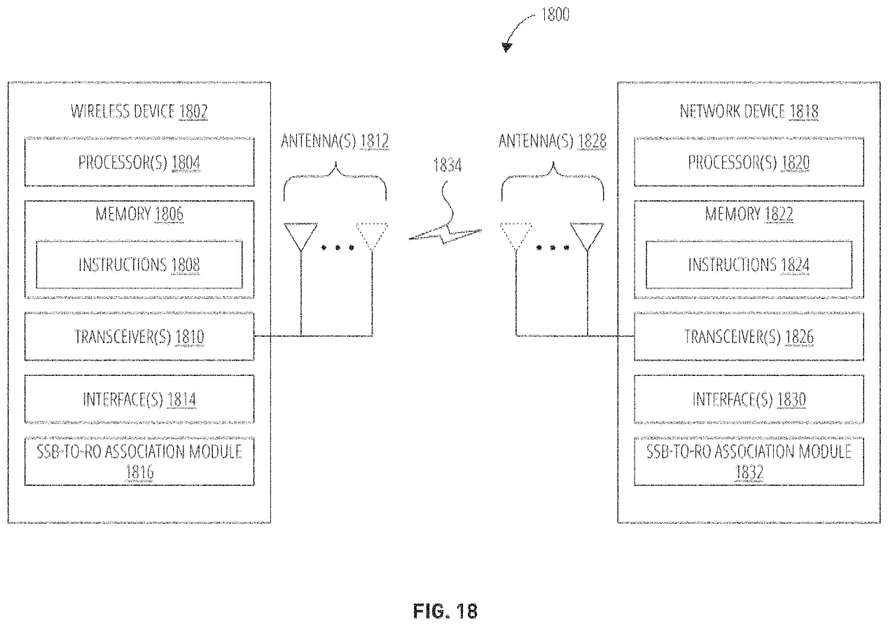

FIG. 18 illustrates a system 1800 for performing signaling 1834 between a wireless device 1802 and a network device 1818, according to embodiments disclosed herein. The system 1800 may be a portion of a wireless communications system as herein described. The wireless device 1802 may be, for example, a UE of a wireless communication system. The network device 1818 may be, for example, a base station (e.g., an eNB or a gNB) of a wireless communication system.

The wireless device 1802 may include one or more processor(s) 1804. The processor(s) 1804 may execute instructions such that various operations of the wireless device 1802 are performed, as described herein. The processor(s) 1804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1802 may include a memory 1806. The memory 1806 may be a non-transitory computer-readable storage medium that stores instructions 1808 (which may include, for example, the instructions being executed by the processor(s) 1804). The instructions 1808 may also be referred to as program code or a computer program. The memory 1806 may also store data used by, and results computed by, the processor(s) 1804.

The wireless device 1802 may include one or more transceiver(s) 1810 that may include radio frequency (RF) transmitter and/or receiver circuitry that use the antenna(s) 1812 of the wireless device 1802 to facilitate signaling (e.g., the signaling 1834) to and/or from the wireless device 1802 with other devices (e.g., the network device 1818) according to corresponding RATs.

The wireless device 1802 may include one or more antenna(s) 1812 (e.g., one, two, four, or more). For embodiments with multiple antenna(s) 1812, the wireless device 1802 may leverage the spatial diversity of such multiple antenna(s) 1812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1802 may be accomplished according to precoding (or digital beamforming) that is applied at the wireless device 1802 that multiplexes the data streams across the antenna(s) 1812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1802 may implement analog beamforming techniques, whereby phases of the signals sent by the antenna(s) 1812 are relatively adjusted such that the (joint) transmission of the antenna(s) 1812 can be directed (this is sometimes referred to as beam steering).

The wireless device 1802 may include one or more interface(s) 1814. The interface(s) 1814 may be used to provide input to or output from the wireless device 1802. For example, a wireless device 1802 that is a UE may include interface(s) 1814 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1810/antenna(s) 1812 already described) that allow for communication between the UE and other devices and may operate according to known protocols (e.g., Wi-Fi®, Bluetooth®, and the like).

The wireless device 1802 may include an SSB-to-RO association module 1816. The SSB-to-RO association module 1816 may be implemented via hardware, software, or combinations thereof. For example, the SSB-to-RO association module 1816 may be implemented as a processor, circuit, and/or instructions 1808 stored in the memory 1806 and executed by the processor(s) 1804. In some examples, the SSB-to-RO association module 1816 may be integrated within the processor(s) 1804 and/or the transceiver(s) 1810. For example, the SSB-to-RO association module 1816 may be implemented by a combination of software components (e.g., executed by a DSP or a general processor) and hardware components (e.g., logic gates and circuitry) within the processor(s) 1804 or the transceiver(s) 1810.

The SSB-to-RO association module 1816 may be used for various aspects of the present disclosure, for example, aspects of FIG. 1 to FIG. 16. The SSB-to-RO association module 1816 may be configured to use RACH configuration information to map PRACH repetitions of random access procedures corresponding to SSBs to a set of configured ROs in one or more of the various manners that have been described herein.

The network device 1818 may include one or more processor(s) 1820. The processor(s) 1820 may execute instructions such that various operations of the network device 1818 are performed, as described herein. The processor(s) 1820 may include one or more baseband processors implemented using, for example, a CPU, a DSP, an ASIC, a controller, an FPGA device, another hardware device, a firmware device, or any combination thereof configured to perform the operations described herein.

The network device 1818 may include a memory 1822. The memory 1822 may be a non-transitory computer-readable storage medium that stores instructions 1824 (which may include, for example, the instructions being executed by the processor(s) 1820). The instructions 1824 may also be referred to as program code or a computer program. The memory 1822 may also store data used by, and results computed by, the processor(s) 1820.

The network device 1818 may include one or more transceiver(s) 1826 that may include RF transmitter and/or receiver circuitry that use the antenna(s) 1828 of the network device 1818 to facilitate signaling (e.g., the signaling 1834) to and/or from the network device 1818 with other devices (e.g., the wireless device 1802) according to corresponding RATs.

The network device 1818 may include one or more antenna(s) 1828 (e.g., one, two, four, or more). In embodiments having multiple antenna(s) 1828, the network device 1818 may perform MIMO, digital beamforming, analog beamforming, beam steering, etc., as has been described.

The network device 1818 may include one or more interface(s) 1830. The interface(s) 1830 may be used to provide input to or output from the network device 1818. For example, a network device 1818 that is a base station may include interface(s) 1830 made up of transmitters, receivers, and other circuitry (e.g., other than the transceiver(s) 1826/antenna(s) 1828 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1818 may include an SSB-to-RO association module 1832. The SSB-to-RO association module 1832 may be implemented via hardware, software, or combinations thereof. For example, the SSB-to-RO association module 1832 may be implemented as a processor, circuit, and/or instructions 1824 stored in the memory 1822 and executed by the processor(s) 1820. In some examples, the SSB-to-RO association module 1832 may be integrated within the processor(s) 1820 and/or the transceiver(s) 1826. For example, the SSB-to-RO association module 1832 may be implemented by a combination of software components (e.g., executed by a DSP or a general processor) and hardware components (e.g., logic gates and circuitry) within the processor(s) 1820 or the transceiver(s) 1826.

The SSB-to-RO association module 1832 may be used for various aspects of the present disclosure, for example, aspects of FIG. 1 to FIG. 16. The SSB-to-RO association module 1832 may be configured to provide, to another wireless device (such as the wireless device 1802) RACH configuration information for mapping PRACH repetitions of random access procedures corresponding to SSBs to a set of configured ROs in one or more of the various manners that have been described herein.

Embodiments contemplated herein include an apparatus comprising means to perform one or more elements of any of the method 1000, the method 1100, the method 1200, the method 1300, and the method 1500. This apparatus may be, for example, an apparatus of a UE (such as a wireless device 1802 that is a UE, as described herein).

Embodiments contemplated herein include one or more non-transitory computer-readable media comprising instructions to cause an electronic device, upon execution of the instructions by one or more processors of the electronic device, to perform one or more elements of any of the method 1000, the method 1100, the method 1200, the method 1300, and the method 1500. This non-transitory computer-readable media may be, for example, a memory of a UE (such as a memory 1806 of a wireless device 1802 that is a UE, as described herein).

Embodiments contemplated herein include an apparatus comprising logic, modules, or circuitry to perform one or more elements of any of the method 1000, the method 1100, the method 1200, the method 1300, and the method 1500. This apparatus may be, for example, an apparatus of a UE (such as a wireless device 1802 that is a UE, as described herein).

Embodiments contemplated herein include an apparatus comprising: one or more processors and one or more computer-readable media comprising instructions that, when executed by the one or more processors, cause the one or more processors to perform one or more elements of any of the method 1000, the method 1100, the method 1200, the method 1300, and the method 1500. This apparatus may be, for example, an apparatus of a UE (such as a wireless device 1802 that is a UE, as described herein).

Embodiments contemplated herein include a signal as described in or related to one or more elements of any of the method 1000, the method 1100, the method 1200, the method 1300, and the method 1500.

Embodiments contemplated herein include a computer program or computer program product comprising instructions, wherein execution of the program by a processor is to cause the processor to carry out one or more elements of any of the method 1000, the method 1100, the method 1200, the method 1300, and the method 1500. The processor may be a processor of a UE (such as a processor(s) 1804 of a wireless device 1802 that is a UE, as described herein). These instructions may be, for example, located in the processor and/or on a memory of the UE (such as a memory 1806 of a wireless device 1802 that is a UE, as described herein).

Embodiments contemplated herein include an apparatus comprising means to perform one or more elements of any of the method 1400 and the method 1600. This apparatus may be, for example, an apparatus of a base station (such as a network device 1818 that is a base station, as described herein).

Embodiments contemplated herein include one or more non-transitory computer-readable media comprising instructions to cause an electronic device, upon execution of the instructions by one or more processors of the electronic device, to perform one or more elements of any of the method 1400 and the method 1600. This non-transitory computer-readable media may be, for example, a memory of a base station (such as a memory 1822 of a network device 1818 that is a base station, as described herein).

Embodiments contemplated herein include an apparatus comprising logic, modules, or circuitry to perform one or more elements of any of the method 1400 and the method 1600. This apparatus may be, for example, an apparatus of a base station (such as a network device 1818 that is a base station, as described herein).

Embodiments contemplated herein include an apparatus comprising: one or more processors and one or more computer-readable media comprising instructions that, when executed by the one or more processors, cause the one or more processors to perform one or more elements of any of the method 1400 and the method 1600. This apparatus may be, for example, an apparatus of a base station (such as a network device 1818 that is a base station, as described herein).

Embodiments contemplated herein include a signal as described in or related to one or more elements of any of the method 1400 and the method 1600.

Embodiments contemplated herein include a computer program or computer program product comprising instructions, wherein execution of the program by a processing element is to cause the processing element to carry out one or more elements of any of the method 1400 and the method 1600. The processor may be a processor of a base station (such as a processor(s) 1820 of a network device 1818 that is a base station, as described herein). These instructions may be, for example, located in the processor and/or on a memory of the base station (such as a memory 1822 of a network device 1818 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
identifying, based on random access channel (RACH) configuration information received from a network, configured RACH occasions (ROs);
mapping, to the configured ROs, a first RO group comprising a first plurality of ROs for transmitting first physical random access channel (PRACH) repetitions of a first random access procedure corresponding to a first synchronization signal block (SSB) of a cell on a first uplink (UL) transmit (Tx) beam, wherein the first plurality of ROs are time domain multiplexed (TDMed), and wherein the first PRACH repetitions comprise repeated transmissions of a first random access preamble of the first random access procedure; and
transmitting, to the network, the first PRACH repetitions using the first plurality of ROs of the first RO group.

2. The method of claim 1, further comprising mapping, to the configured ROs, a second RO group comprising a second plurality of ROs for transmitting second PRACH repetitions of a second random access procedure corresponding to a second SSB of the cell on a second UL Tx beam, wherein the second plurality of ROs are TDMed.

3. The method of claim 2, wherein the second RO group uses a same frequency resource as the first RO group and is TDMed with the first RO group.

4. The method of claim 2, wherein the second RO group is frequency division multiplexed (FDMed) with the first RO group.

5. The method of claim 2, wherein each of the first RO group and the second RO group are mapped to the configured ROs within a first RO group association period that includes a set of RO groups having at least one RO group for each of a set of SSBs used by the cell.

6. The method of claim 5, wherein the set of RO groups is ordered within the RO group association period first in a time domain and then in a frequency domain according to their corresponding ones of the set of SSBs.

7. The method of claim 5, wherein the set of RO groups is ordered within the RO group association period first in a frequency domain and then in a time domain according to their corresponding ones of the set of SSBs.

8. The method of claim 5, wherein an association pattern period used at the UE is an integer multiple of the RO group association period.

9. The method of claim 2, wherein the RACH configuration information further includes:
first repetition level configuration information indicating a first repetition level defining a first PRACH repetition number and a first reference signal receive power (RSRP) corresponding to the first PRACH repetition number; and
second repetition level configuration information indicating a second repetition level defining a second PRACH repetition number that is different that the first PRACH repetition number and a second RSRP corresponding to the second PRACH repetition number.

10. The method of claim 9, wherein:
the first RO group uses the first repetition level such that a first number of the first PRACH repetitions of the first RO group is equal to the first PRACH repetition number of the first repetition level;
the second RO group uses the second repetition level such that a second number of the second PRACH repetitions of the second RO group is equal to the second PRACH repetition number of the second repetition level; and
the first RO group and the second RO group are part of a same RO group association period that is determined based on a maximum between the first PRACH repetition number of the first repetition level and the second PRACH repetition number of the second repetition level.

11. The method of claim 9, wherein:
the first RO group uses the first repetition level such that a first number of the first PRACH repetitions of the first RO group is equal to the first PRACH repetition number of the first repetition level;
the second RO group uses the second repetition level such that a second number of the second PRACH repetitions of the second RO group is equal to the second PRACH repetition number of the second repetition level;
the first RO group is part of a first RO group association period for RO groups using the first repetition level; and
the second RO group is part of a second RO group association period for RO groups using the second repetition level.

12. The method of claim 1, wherein the first RO group is within a first RO group association period and on a first frequency resource, and further comprising:
determining that a second RO group comprising a second plurality of ROs for transmitting second PRACH repetitions of a second random access procedure cannot be mapped in a TDMed manner to one or more unused ROs of the configured ROs that are on the first frequency resource and within the first RO group association period; and
dropping the one or more unused ROs.

13. The method of claim 1, further comprising:
transmitting to the network, a capability message indicating that the UE can use an RO grouping scheme where RO groups comprising TDMed PRACH repetitions are ordered within the configured ROs; and
receiving, from the network, a system information message indicating that the UE is to use the RO grouping scheme.

14. A method of a user equipment (UE), comprising:
identifying, based on first random access channel (RACH) configuration information received from a network, first one or more configured RACH occasions (ROs) that are usable for random access without physical random access channel (PRACH) repetition behavior;
identifying, based on second RACH configuration information received from the network, second one or more configured ROs that are dedicated for random access with the PRACH repetition behavior; and
transmitting, to the network, first PRACH repetitions of a first random access procedure corresponding to a synchronization signal block (SSB) on a first uplink (UL) transmit (Tx) beam using the first one or more configured ROs and the second one or more configured ROs, wherein the first PRACH repetitions comprise repeated transmissions of a first random access preamble of the first random access procedure.

15. The method of claim 14, wherein the second one or more configured ROs immediately follow the first one or more configured ROs in a time domain.

16. The method of claim 15, wherein the second one or more configured ROs use a same frequency resource as the first one or more configured ROs.

17. The method of claim 14, wherein the first one or more configured ROs is associated with the SSB when the first RACH configuration information is applied at the UE.

18. A method of a user equipment (UE), comprising:
identifying, based on first random access channel (RACH) configuration information received from a network, first configured RACH occasions (ROs) that are dedicated for random access with physical random access channel (PRACH) repetition behavior; and
transmitting, to the network, first PRACH repetitions of a first random access procedure corresponding to a synchronization signal block (SSB) on a first uplink (UL) transmit (Tx) beam using the first configured ROs, wherein the first PRACH repetitions comprise repeated transmissions of a first random access preamble of the first random access procedure;
wherein the first PRACH transmissions do not use second configured ROs that are usable for random access without the PRACH repetition behavior.

19. The method of claim 18, wherein the first configured ROs use different frequency resources from the second configured ROs.

20. The method of claim 18, where a first number of the first configured ROs is greater than a second number of the second configured ROs.

21.-23. (canceled)
